(19) United States
(12) Patent Application Publication
(10) Pub. No.: US 2026/0091460 A1
(43) Pub. Date: Apr. 2, 2026

(54) METHOD FOR DETERMINING WHETHER A MACHINE TOOL HAS WARMED UP, MACHINE TOOL AND METHOD FOR MACHINING WORKPIECES

(71) Applicant: Fill Gesellschaft m.b.H., Gurten (AT)

(72) Inventors: Gerald KETTL, Eberschwang (AT); Michael GILLHOFER, Linz (AT); Verena STANZL, Krems (AT)

(73) Assignee: Fill Gesellschaft m.b.H., Gurten (AT)

(21) Appl. No.: 19/103,885

(22) PCT Filed: Aug. 16, 2023
(86) PCT No.: PCT/AT2023/060274

§ 371 Date: Feb. 14, 2025

(30) Foreign Application Priority Data
Aug. 16, 2022 (AT) A50627/2022

(51) Int. Cl. B23Q 15/20

(52) U.S. Cl. CPC B23Q 15/20

(57) ABSTRACT

In a method for determining whether a machine tool with a numerical control system for machining a workpiece has warmed up, axis data are obtained which relate to a position of a tool of the machine tool. An indication value is calculated therefrom. It is then determined whether the indication value reaches a predefined threshold value. Furthermore, it is determined whether the machine tool has warmed up, wherein reaching the indication value of the threshold value indicates that the machine tool has warmed up. A method and a machine tool machines workpieces, a computer program product instructs the machine tool, a computer-readable medium stores the computer program product, and a method machines workpieces by the machine tool.

The invention relates to determining whether a machine tool with a numerical control for machining a workpiece has warmed up. It is assumed that during warm-up, movements required for machining the workpiece are performed in a single sequence. This process is repeated in several runs until the machine tool has warmed up.

A method for detecting the thermal stability of machine tools and automating the warm-up process to improve process stability and production quality is presented.

In machine tools intended for machining or manufacturing workpieces, thermal changes result in physical effects on the mechanics. Changes in the mechanics cannot guarantee the exact position of high-precision machining operations (e.g. bores) and therefore the quality of the components produced. It is therefore common practice to warm up such machines before productive use. The duration of this process is not yet known exactly and is set according to the state of the art based on experience. The necessity or duration of warming up after a standstill is also not known. Too short a warm-up time leads to rejects, too long a warm-up time takes time for operation and thus leads to lower efficiency.

DE 10 2018 001 830 A discloses a device for planning a warm-up operation, which creates a warm-up operation plan for a machine tool for machining a workpiece as a machining target. This records an assignment of at least one warm-up operation program to information about a workpiece to be machined by the machine tool and a throughput time in the warm-up operation program. A warm-up operation program is selected based on a machining plan and the duration of the warm-up operation is calculated based on the cycle time associated with the selected warm-up operation program. The warm-up operation is planned by creating a warm-up operation plan for the machine tool comprising a start time and an end time of a warm-up operation based on the entered machining plan and the calculated duration of the warm-up operation. A previously recorded operating time of the machine tool is taken into account.

DE 10 2013 101 346 A discloses a control device for warming up a machine tool, in which a warm-up control device for a machine tool is activated before machining a workpiece, which performs a warm-up run in which a main shaft rotary drive means and axis drive means are set in motion. A calculation formula obtained in advance is used, which provides the thermal displacement parameter depending on the speed of the main shaft and the load of the main shaft motor. The amount of displacement caused by the heat generated after starting the warm-up, which changes depending on time, is calculated in each predetermined time period. Depending on the thermal displacement value, a decision is made as to whether the warm-up should be terminated. Depending on the thermal displacement parameter, a decision is also made as to whether the warm-up should be restarted after the end of the warm-up. If a warm-up restart is determined, the warm-up is started again. To adapt the method to other environments, operating conditions must be set differently.

A disadvantage of the prior art is that a plan must be made in advance or a formula must be obtained in advance, and the process thus loses efficiency because it cannot take into account changes in conditions, e.g. room temperature or mechanical wear of the axles, or requires the user to manually adjust the time period or the permissible value.

The object of the present invention is to overcome the disadvantages of the prior art and to present an alternative. A method for determining whether a machine tool with a numerical control for machining a workpiece has warmed up, a machine tool for machining a workpiece, a method for machining a workpiece, a computer program product, and a computer-readable medium are provided.

This object is solved by the devices or methods according to the independent claims. Further advantageous advancements can be found in the dependent claims.

The advantage here is that the warm-up process can be carried out by software control based on the results of a model without additional sensors. The process is purely data-driven and does not require any sensors or measuring devices. The method is therefore based exclusively on the position data of the axes. By recognizing a convergence of the calculated indication value, i.e. the stability indicator, the warm-up process is fully automated.

Compared to the state of the art, the calculation formula is solely dependent on the actual axis positions and no values for the speed or load of the motor are required. This means that no formula needs to be generated in advance. In addition, the method presented does not calculate and evaluate the difference between a maximum value and a minimum value of the displacement parameter, but instead obtains a characteristic parameter for the difference between two encoder systems and observes the convergence of the characteristic parameter. With the convergence towards a limit or threshold value, it can be concluded that no further mechanical expansion takes place.

A further advantage compared to the state of the art is that no adjustments, for example by a user, are necessary when adapting to other environments. This is achieved because this method also takes into account possible influences due to changes in the hall temperature and influences due to mechanical wear, and therefore no manual adjustments (e.g. by a user) are required. In other words, the present method does not use a defined formula based on user input parameters to obtain the thermal displacement parameter, as in the prior art. The method presented takes into account all external influences (such as room temperature, wear, etc.) without further adjustments (e.g. by a user).

The process can be integrated into both existing and new machine tools. Costs, energy and materials can be saved by optimizing accomplished by the method.

The project that led to this application has received funding from the European Union's Horizon 2020 research and innovation program under grant agreement No 871536.

According to a first embodiment, a method according to the invention for determining whether a machine tool with a numerical control for machining a workpiece has warmed up comprises obtaining axis data relating to a position of a tool of the machine tool. The method further comprises calculating an indication value from the axis data. It then determines whether the indication value reaches a predetermined threshold value and determines whether the machine tool has warmed up, wherein reaching the indication value of the threshold value indicates that the machine tool has warmed up.

According to a further embodiment, a machine tool for machining a workpiece with a numerical control is provided. The machine tool comprises a calculating device which is configured to obtain axis data and calculate an indication value from the axis data. The calculating device can then determine whether the indication value reaches a predetermined threshold value and whether the machine tool has warmed up, wherein it is determined that the machine tool has warmed up if it is determined that the indication value reaches the threshold value.

The method or machine tool according to the invention can ensure an efficient warm-up process that does not require any additional measurements or data to be collected.

In the method, obtaining axis data may comprise acquiring the axis data by at least two measuring devices and/or reading out the axis data from a memory, a database or a data carrier.

The machine tool may further comprise at least two measuring devices which are configured to acquire axis data relating to a position of a tool of the machine tool and transfer them to the calculating device. Alternatively or additionally, the machine tool may comprise a data storage device, such as a memory, a database or a data carrier, in which axis data are stored and which is configured to transfer stored axis data to the calculating device.

By using measurement data and/or stored axis data, calculating the indication value and determining can be further improved.

The measuring devices may be transmitters, i.e. encoders or transducers such as rotary transducers, or direct measuring systems.

In particular, at least one measuring device may be attached to a motor that moves a tool of the machine tool, and at least one measuring device may be a direct measuring system.

The indication value may be calculated using a regression model, or the calculation device may be configured to calculate the indication value using a regression model.

It has been shown that a regression model is particularly suitable for the calculation. A simple linear regression model is based on an influencing variable x and a target variable y. With the help of two parameters, a straight line is laid through a point cloud of the existing values of the axis positions in such a way that the linear relationship between x and y is described as accurately as possible and an error constant ¿ is minimized.

Specifically, the formula for the regression line is as follows:

$$y = kx + d + ε$$

The value k describes the indication value that is used for further consideration.

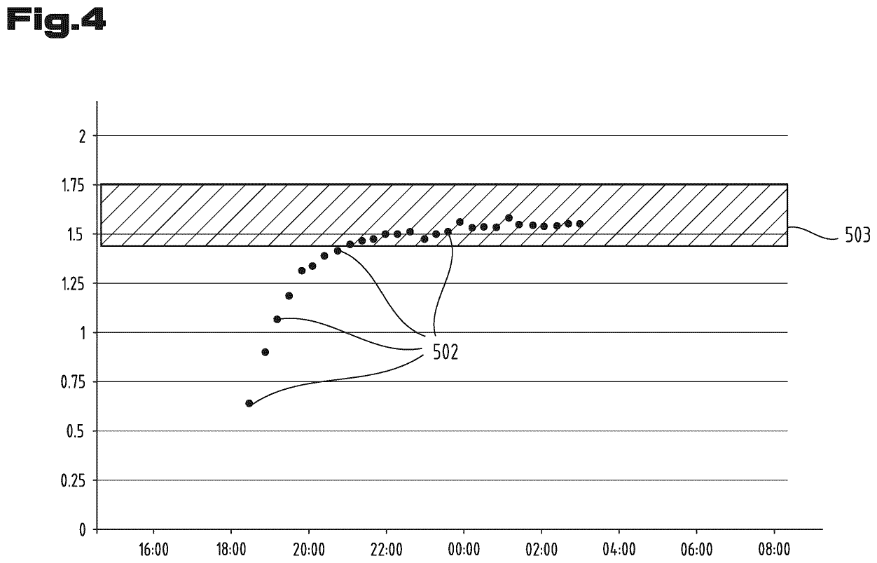

The values of the axis positions depend on the physical dimensions of the installed geometry axes. With a length of 300 mm, example values are in the range of −150 mm to +150 mm. For example, the difference between the two measuring systems is in the range of 0 mm to 0.2 mm. The calculated indicator value then results from the slope of the calculated regression line and is, for example, in the range of 0.5 to 1.75. This value increases with the thermal expansion and can be defined with the limit value in the event of convergence. FIG. 4, for example, shows a limit value of approximately 1.5.

Determining whether the indication value reaches a predetermined threshold value may be done by detecting a convergence of the indication value against the threshold value as a limit value. The calculating device may also be configured to determine whether the indication value reaches a predetermined threshold value by detecting a convergence of the indication value against the threshold value as a limit value.

It has been shown that the convergence is a reliable means for determining when the threshold value has been reached.

The method may further be improved by acquiring and/or reading out temperature values from at least one temperature sensor in the machine tool, and by taking the acquired and/or read out temperature values into account when determining whether the machine tool has warmed up.

The machine tool may further comprise at least one temperature sensor, and the calculating device may be configured to take into account temperature values of the temperature sensors when determining whether the machine tool has warmed up.

The additional use of temperature sensors may further optimize the warm-up process.

The machine tool may be controlled using the information from determining whether the machine tool has warmed up. The control includes at least one element of the group comprising warm-up start, warm-up continuation, warm-up stop, machining start, machining stop and modification of the numerical control information for machining. A combination of these is also possible. In the further embodiment, the calculating device may further be configured to control the machine tool based on determining whether the machine tool has warmed up, wherein controlling comprises at least one element of the group comprising warm-up start, warm-up continue, warm-up stop, machining start, machining stop, and modifying the numerical control information for machining. A combination of these is also possible.

By being able to control the machine tool based on determining whether it has warmed up, machining of the workpiece can be fully automated.

According to a further embodiment of the invention, a computer program is provided, comprising instructions which, when the program is executed by a computer, cause the computer to perform a method according to the invention. The computer program product may be stored on a computer-readable medium.

According to a further embodiment of the invention, a method for machining a workpiece is provided by the machine tool according to the invention.

The embodiments show possible embodiment variants, wherein the invention is not limited to the specifically shown embodiment variants thereof, but rather combinations of the individual embodiment variants with one another are also possible.

For a better understanding of the invention, it is explained in more detail with the aid of the following figures.

The figures show in a very simplified, schematic representation:

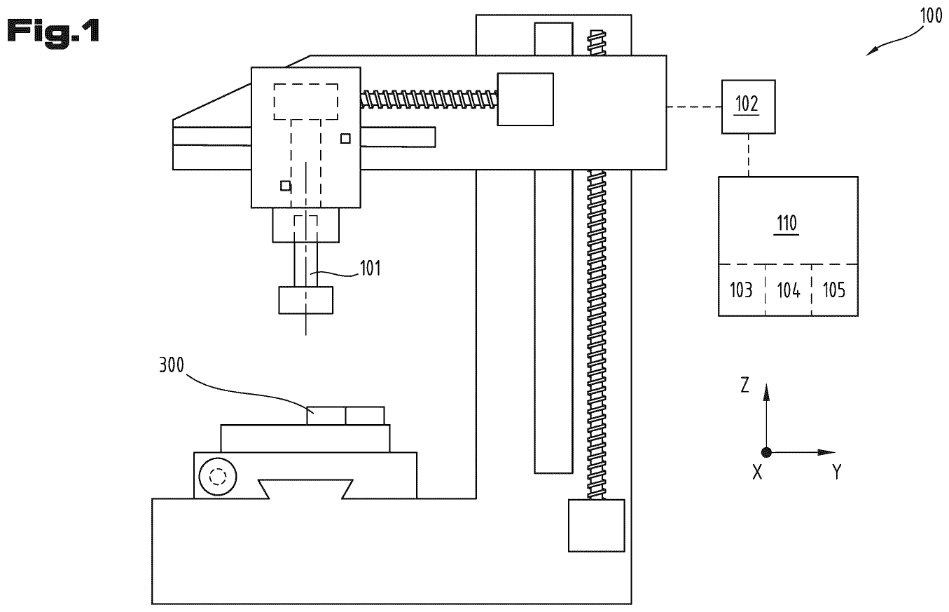

FIG. 1 a machine tool with a tool for machining a workpiece according to an embodiment;

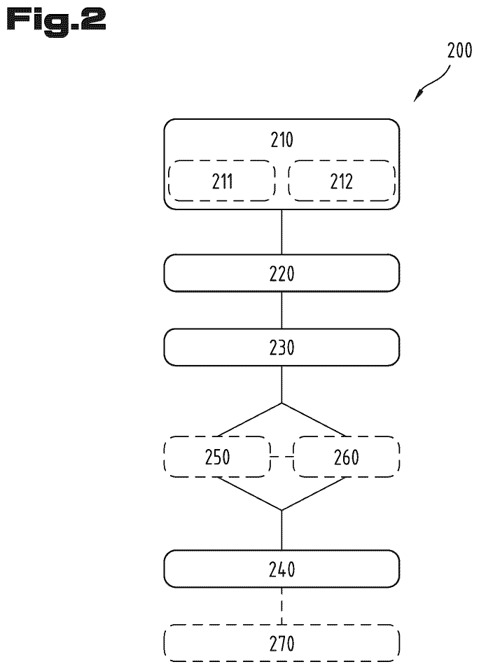

FIG. 2 a schematic flow chart according to an embodiment;

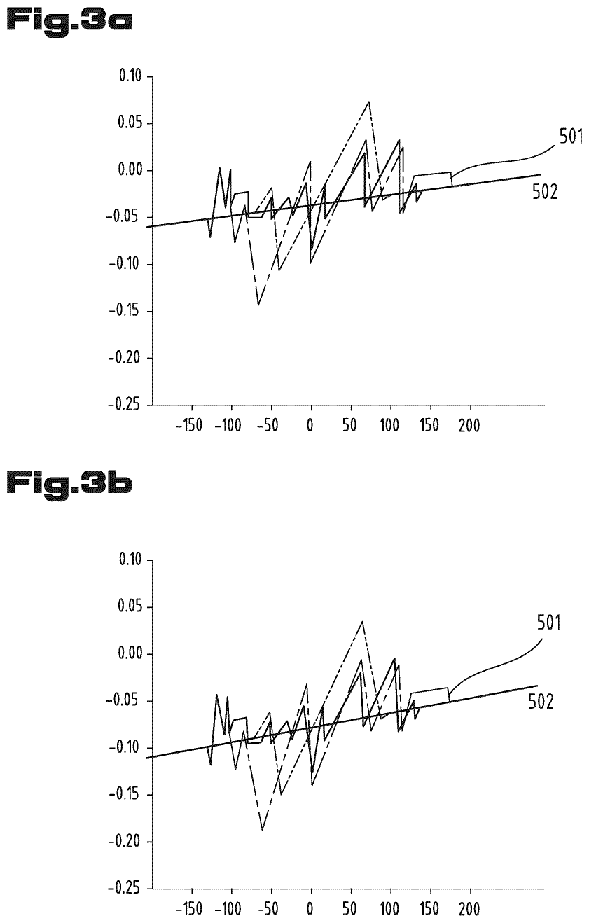

FIG. 3 the relationship between axis data and indication values in an exemplary way, and

FIG. 4 the course of the detection of the convergence of the indication value.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

The description of the features of the embodiments below applies equally to the method and the machine tool, even if reference is only made to one of the two forms. The same applies to the computer program product and the computer-readable medium.

The method may be summarized as follows:

Obtaining axis data, for example by reading out the relevant data for the thermal stability indicator from the numerical control (NC) system

Optionally, the data may also be processed, i.e. sorted, filtered, etc., or sent for other processing.

Calculating an indication value from the axis data, for example by sequentially calculating the thermal stability indicator based on axis data using a regression model for all three geometric machining planes (x, y, z), wherein, for example, two transducer positions are sensed, for example on the motor and on the outside of the axis. The distance between the positions is then obtained, e.g. measured, as this changes due to heat.

Determining whether the indication value reaches a predetermined threshold value, for example by detecting the convergence of the indicator.

Determining whether the machine tool has warmed up, for example as a decision as to whether the process of warm-up or non-warm-up should be carried out. This result may then be fed back into the active process of the machine.

Optionally, based on this result, the machine control system may then automatically start, continue or cancel the warm-up process.

FIG. 1 shows a machine tool 100 with a tool 101. This tool may be a milling head, a drill, a brush or another cutting tool that engages in a workpiece 300 to remove material. The tool is controlled by a numerical control 102 and put in rotation by a spindle. The machine tool may comprise a calculating device 110. Alternatively, the calculating device may also be a stand-alone device.

According to the flowchart shown in FIG. 2, axis data 501 are first obtained from the calculating device 110 in step 210. The axis data 501 describe the respective position of the axes of the machine tool 100. The method can be performed continuously. Alternatively, determining that the machine tool has warmed up may also be interpreted as an abort condition, so that the method then ends. Steps 210, 220, 230 and 240 are then carried out in each run.

The axis data 501 may be supplied to the calculating device 110 in various ways.

The calculating device 110 consists of or comprises at least one processor or CPU (central processing unit). The calculating device 110 may also comprise a plurality of processors, one or more of which may also be supporting processors, such as graphics processing units (GPUs). Processors from other computers may also be used, i.e. the processing is outsourced.

The calculating device 110 may further comprise a data storage device 106 on which input data, output data, intermediate result data and/or program data may be stored. Control data of the numerical control may also be stored on the data storage device 106. The data storage device 106 may relate to a memory 103, a database 104 and/or a data carrier 105, the latter being connected to the calculating device 110 or the machine tool 100 in a corresponding interface, such as a drive, or wired or wireless interface.

The data storage device 106 does not have to be a part of the calculating device 110; it may also be remote, i.e. connected via a wired or wireless interface, such as a network.

Obtaining 210 the axis data 501 may be effected by acquiring 211 axis data 501 by measuring devices. Alternatively or additionally, however, the axis data 501 may also be obtained by reading out 212 from a data storage device 106. As already described, the data storage device 106 may take the form of a memory 103, a database 104 and/or a data carrier 105. A combination of these is also possible.

The use of stored axis data 501 has the particular advantage that an already performed warm-up can be evaluated, re-simulated and its results can also be used for future warm-ups.

FIG. 3 shows the axis positions of the tool 101. The values are plotted on the axes in nanometers. The x axis refers to the position of the tool 101 in one axis in relation to the machine tool, the y axis refers to another axis.

FIG. 3a shows the movements of the tool 101 during a first run of the movements required for machining, while FIG. 3b shows the movements during a second run. The two runs shown are not directly consecutive, but are merely intended to illustrate the course of the change.

It may be seen that the movements are similar but have a different position. For example, the first run moves in a range between 0.10 and −0.15 mm, while the second run moves in a range between 0.05 and −0.20 mm.

An indication value 502 is then calculated in step 220 using the axis data 501. The indication value 502 represents a thermal stability indicator which shows the stability of the mechanics of the machine tool 100, i.e. how variable the mechanics are with regard to thermal changes.

The indication value 502 may be determined using a linear regression, for example. This is also shown as an example in FIG. 3. The line provided with the reference sign of the indication value 502 is also to be understood here as a schematic representation.

The gradient k can be calculated for the straight line determined in this way. This gradient k then corresponds to the indication value 502.

In the following step 230, a predetermined threshold value 503 is then used to determine whether the indication value 502 reaches this threshold value 503. This is illustrated by FIG. 4. The x axis in FIG. 4 is plotted over time, wherein 2 hours are between the markings on the x axis as an example. The y axis carries the values 0 to 2, in which the gradient k is plotted as the indication value 502.

The threshold value 503 is the lower limit of the gray-shaded area, which starts at around 1.45 in FIG. 4 as an example. If the indication value 502 now reaches or exceeds the threshold value 503, this reaching or exceeding is determined in step 230.

Determining 230 whether the indication value 502 reaches a predetermined threshold value 503 may be performed, for example, by detecting a convergence of the indication value 502 against the threshold value 503 as a limit value.

Reaching the indication value 502 of the threshold value 503 indicates that the machine tool 100 has warmed up.

Optionally, temperature values may be obtained from at least one temperature sensor in the machine tool 100. In principle, this may happen at any time during the method. In FIG. 2, steps 250 and 260 are shown for this purpose, although these could also take place before determination step 230 or even before calculation step 220. These steps may be used to acquiring 250 and/or reading out 260. Both alternatives may also be used. Acquiring 250 refers to measuring temperatures during the run, while reading out 260 refers to obtaining the temperature values from, for example, a data storage device 106.

This may then be used for determining in the following step 240 and terminating the method. If temperature values were obtained in steps 250 and/or 260, these may be taken into account when determining in step 240 whether the machine tool 100 has warmed up.

For example, even if the indication value 502 has reached the threshold value 503 but the machine tool 100 has not yet reached a lower temperature limit, it may be determined that the machine tool 100 has not yet warmed up.

It should be noted that the threshold value 503 usually consists of one value. However, it is also possible for the threshold value 503 to be represented by a range, as shown in FIG. 4. In this case, the threshold value 503 would be an operating range that should not be exceeded, even at the upper end.

If the method 200 has not yet been terminated, an optional step 270 of controlling the machine tool 100 based on the result of the determining step 240 may be performed. Here, the machine tool 100 is controlled in such a way that one or more control signals are sent to the machine tool 100 in order to execute one or more of the following operations: warm-up start, warm-up continuation, warm-up stop, machining start, machining stop and modification of the numerical control information for machining. A combination of these operations may also be sent as a signal to the machine tool 100.

The numerical control information may be modified, for example, if it is determined that the indication value 502 converges to a value that is below the threshold value 503. In contrast to a manual adjustment of the threshold value 503, the numerical control could also be adjusted in this case so that the distances during machining are changed in such a way as to compensate for a lack of thermal expansion of the tool 101 or the machine tool 100, for example.

In particular, the method 200 may be continued even after the start of processing of workpieces 300, and by determining whether the indication value 502 has reached or exceeded the threshold value 503, it may be determined if other detrimental thermal-induced changes in the mechanics occur. This could, for example, be an overheating, whereby the indication value 502 falls below the threshold value 503 or exceeds the range of the threshold value 503 upwards, i.e. out of the operating range. In this case, a machining stop could be sent in step 270.

As previously described, the features previously described with respect to the method 200 are equally applicable to the machine tool 100.

In particular, the machine tool 100 may comprise at least two measuring devices which may take the form, for example, of transmitters, i.e. encoders or transducers such as rotary transducers, or direct measuring systems.

Advantageously, at least one measuring device is attached to a motor that moves a tool 101 of the machine tool 100, and at least one measuring device is a direct measuring system. Both are not shown in FIG. 1.

The first measuring device may therefore be a rotary transducer directly on the motor. This is also known as an indirect measuring system, as the measured value is derived from the motor movement.

The second measuring device, on the other hand, may be a direct measuring system in which the position of the axis is actually measured. This may be done using a laser or similar, for example. The actual axis position is measured directly, i.e. from the outside.

The difference between the two possible measuring devices is that with the first measuring device, a distance is already taken into account when the motor is moved, but due to mechanical influences (e.g. play between gears, wear, etc.), this does not actually affect the axis until later.

However, the axis is already considered to be offset in the program when the motor moves.

However, because the real value of the axis position is measured from the outside with the second measuring device, the above-mentioned influences may be determined and taken into account. The second measuring device may be stationary, i.e. attached to the tool 101 or the machine tool 100, but alternative possibilities also exist. For example, a laser head may move along the axis and measure a reference position, or vice versa, i.e. the laser head is stationary and a measuring scale or coding to be measured moves along the axis, i.e. is moved along with the axis movement.

The difference between the different measuring devices changes during warm-up of the machine tool 100 and can be observed.

In other words, the second measuring device measures the actual position of the axis. There are different types depending on the machine design. One example is a measuring head that is mounted in a fixed way and measures a reference point (e.g. a coded metal strip). Another example is a measuring head that moves along the axis and measures a reference point (on the fixed, coded metal strip).

The machine tool 100 may also itself comprise corresponding elements that enable it to carry out the method 200 as set out above.

A further embodiment is a computer program product comprising instructions which, when the program is executed by a computer, cause the computer to perform the method 200 described above.

A further embodiment is a computer-readable medium on which the computer program product is stored.

A further embodiment is a method 400 for machining a workpiece 300 by the previously described machine tool 100.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or combinations of features from the different exemplary embodiments shown and described may represent independent inventive solutions. The object underlying the independent inventive solutions can be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### REFERENCE SIGNS LIST

100 machine tool
101 tool
102 numerical control
103 memory
104 database
105 data carrier
106 data storage device
111 calculating device
200 method for determining whether a machine tool has warmed up
210 obtaining the axis data
211 acquiring the axis data
212 reading out the axis data
220 calculating the indication value
230 determining whether the indication value reaches a threshold value
240 determining whether the machine tool has warmed up
250 acquiring temperature values
260 reading out temperature values
270 controlling the machine tool
300 workpiece(s)
501 axis data
502 indication value
503 threshold value

1: A computer-implemented method (200) for determining whether a machine tool (100) having a numerical control (102) for machining a workpiece (300) has warmed up, comprising:
obtaining (210) axis data (501) relating to a position of a tool (101) of the machine tool (100);
calculating (220) an indication value (502) from the axis data (501);
determining (230) whether the indication value (502) reaches a predetermined threshold value (503); and
determining (240) whether the machine tool (100) has warmed up, wherein reaching the indication value (502) of the threshold value (503) indicates that the machine tool (100) has warmed up.

2: The method (200) according to claim 1, wherein obtaining (210) axis data (501) comprises
acquiring (211) the axis data (501) by at least two measuring devices, and/or
reading out (212) the axis data (501) from a data storage device (106), such as a memory (103), a database (104) or a data carrier (105).

3: The method (200) according to claim 1, wherein calculating (220) the indication value (502) is performed using a regression model.

4: The method (200) according to claim 1, wherein determining (230) whether the indication value (502) reaches a predetermined threshold value (503) is performed by detecting a convergence of the indication value (502) against the threshold value (503) as a limit value.

5: The method (200) according to claim 1, further comprising acquiring (250) and/or reading out (260) temperature values from at least one temperature sensor in the machine tool (100), and wherein determining (240) whether the machine tool (100) has warmed up takes the temperature values into account.

6: The method (200) according to claim 1, further comprising controlling (270) the machine tool (100) based on determining (240) whether the machine tool (100) has warmed up, wherein controlling (270) comprises at least one element of the group comprising warm-up start, warm-up continue, warm-up stop, machining start, machining stop, and modifying the numerical control information for machining, or a combination thereof.

7: A machine tool (100) for machining a workpiece (300), having:
a numerical control (102); and
a calculating device (110) which is configured to
obtain axis data (501);
calculate an indication value (502) from the axis data (501);
determine whether the indication value (502) reaches a predetermined threshold value (503); and
determine whether the machine tool (100) has warmed up, wherein it is determined that the machine tool (100) has warmed up when it is determined that the indication value (502) reaches the threshold value (503).

8: The machine tool (100) according to claim 7, further having
at least two measuring devices which are configured to acquire axis data (501) relating to a position of a tool (101) of the machine tool (100) and to transfer them to the calculating device (110); and/or
a data storage device (106), such as a memory (103), a database (104) or a data carrier (105), in which axis data (501) are stored, and which is configured to transfer stored axis data (501) to the calculating device (110).

9: The machine tool (100) according to claim 7, wherein the calculating device (100) is configured to calculate the indication value (502) using a regression model.

10: The machine tool (100) according to claim 7, wherein the calculating device (110) is configured to determine whether the indication value (502) reaches a predetermined threshold value (503) by detecting a convergence of the indication value (502) against the threshold value (503) as a limit value.

11: The machine tool (100) according to claim 7, further having at least one temperature sensor, wherein the calculating device (110) is configured to take temperature values of the temperature sensors into account when determining whether the machine tool (100) has warmed up.

12: The machine tool (100) according to claim 7, wherein the calculating device (110) is further configured to control the machine tool (100) based on determining whether the machine tool (100) has warmed up, wherein controlling comprises at least one element of the group comprising warm-up start, warm-up continue, warm-up stop, machining start, machining stop, and modifying the numerical control information for machining, or a combination thereof.

13: The machine tool (100) according to claim 8, wherein the measuring devices are transmitters, i.e. encoders or transducers such as rotary transducers, or direct measuring systems.

14: The machine tool (100) according to claim 8, wherein at least one measuring device is attached to a motor that moves a tool (101) of the machine tool (100), and at least one measuring device is a direct measuring system.

15: A computer program product comprising instructions which, when executed, cause the machine tool (100) according to claim 7 to perform a computer-implemented method (200) for determining whether the machine tool (100) has warmed up, comprising:
obtaining (210) axis data (501) relating to a position of a tool (101) of the machine tool (100);
calculating (220) an indication value (502) from the axis data (501);
determining (230) whether the indication value (502) reaches a predetermined threshold value (503); and
determining (240) whether the machine tool (100) has warmed up, wherein reaching the indication value (502) of the threshold value (503) indicates that the machine tool (100) has warmed up.

16: A computer-readable medium on which the computer program product according to claim 15 is stored.

17: A method (400) for machining a workpiece (300) by the machine tool (100) according to claim 8.
